(19) United States
(12) Patent Application Publication
(10) Pub. No.: US 2013/0125451 A1
(43) Pub. Date: May 23, 2013

(54) METHOD FOR REPELLING AND/OR CONTROLLING PESTS

(71) Applicants: Alan E. Brandt, Chapel Hill, NC (US); Neil P. Ranaweera, Kelston (NZ)

(72) Inventors: Alan E. Brandt, Chapel Hill, NC (US); Neil P. Ranaweera, Kelston (NZ)

(73) Assignee: ENTOGENEX INTERNATIONAL, LTD., Kuala Lumpur (MY)

(21) Appl. No.: 13/813,679

(22) PCT Filed: Jul. 29, 2011
(86) PCT No.: PCT/MY2011/000181

§ 371 Date: Feb. 1, 2013

(30) Foreign Application Priority Data
Aug. 2, 2010 (MY) PI 2010003649

(51) Int. Cl. A01N 65/26; A01N 35/02; A01M 11/00

(52) U.S. Cl. CPC A01N 65/26; A01M 11/00; A01N 35/02
USPC 43/132.1; 424/769

(57) ABSTRACT

A method and composition for repelling and/or controlling at least one pest. The method comprising contacting at least one subject, article and/or locus with a composition comprising (i) 2-undedanone, 2-tridecanone or a mixture thereof; and (ii) neem plant, part and/or extract thereof.

### FIELD OF THE INVENTION

The present invention relates to methods and formulations for repelling and/or controlling pests, particularly for repelling arthropods such as mosquitoes, flies, termites, bed bugs, bed mites, dust mites and ticks.

### BACKGROUND TO THE INVENTION

Pests, such as mosquitoes, flies, mites and ticks are known to be a nuisance to mankind. Most of them are disease carriers and pose significant problems for man in both the economic and health care sectors. Accordingly, to kill, repel and/or control pests, insecticides or repellents are used in areas where the presence of these pests is not desired. However, commercially available insecticides and/or repellents generally include active ingredients which are toxic to both the target pests and to the user especially if the insecticides and repellents are used in relatively confined environments and delivered as aerosol sprays.

U.S. Pat. No. 7,288,573 and U.S. Pat. No. 6,437,001 both disclose the use of less toxic insecticides. However, the effectiveness of these insecticides in killing/repelling pests is greatly compromised with the reduction in the toxicity of the insecticides.

U.S. Pat. No. 7,531,188 discloses other pest combating compositions containing soy methyl ester as a base ingredient which is added to other pest repelling compounds, such as 2-undecanone and N,N-diethyl-meta-toluamide (DEET). However, the use of soy methyl ester increases the volatility of the formulation thus limiting the duration of the effectiveness of the insecticide.

There is thus a need to provide an insecticide and/or repellent that is capable of providing greater repelling effects, with reduced toxicity to the user, and which has prolonged residence compared to those presently available. This will result in a smaller quantity of insecticides necessary to give the same repelling effect.

Effective repellents are also needed to reduce the spread of infectious diseases which are spread by pests. An insecticide and/or repellent that prevents or reduces the number of landings and bites of pests may also reduce the spread of infectious diseases.

### SUMMARY OF THE INVENTION

The present invention addresses the problems above, and in particular provides a novel and effective composition and method that may be used in repelling and/or controlling at least one pest effectively.

According to a first aspect, the present invention provides a method of repelling and/or controlling at least one pest, the method comprising contacting at least one subject, article and/or locus with a composition comprising:
(i) 2-undecanone, 2-tridecanone or a mixture thereof; and
(ii) neem plant, part and/or extract thereof.

According to another aspect, the present invention provides a composition for repelling and/or controlling at least one pest, the composition comprising:
(i) 2-undecanone, 2-tridecanone or a mixture thereof; and
(ii) neem plant, part and/or extract thereof.

The combination of the two compounds in the composition may result in a prolonged residence time of the active compounds, thus effectively killing and/or repelling pests.

### BRIEF DESCRIPTION OF THE FIGURES

FIG. 1 is a graph showing the mean percentage repellence of Moustique EGX-101® (2-undecanone) compared to 2% Neem oil against Aedes aegypti mosquitoes at (a) 60 seconds, (b) 90 seconds and (c) 120 seconds exposure time.

FIG. 2 is an illustration of a cage with two compartments divided by a Perspex partition in the middle used in as shown in the SIRIM protocol in the Example.

### DETAILED DESCRIPTION OF THE PREFERRED EMBODIMENTS

Bibliographic references mentioned in the present specification are for convenience listed in the form of a list of references and added at the end of the examples. The whole content of such bibliographic references is herein incorporated by reference.

### DEFINITIONS

The terms “a” and “an” are used herein to refer to one or to more than one (i.e. at least one) of the grammatical object of the article. By way of example, “an element” means one element or more than one element.

The term “article” includes but is not limited to apparel or garments, belts, collars, products made of polymers, textile, at least one part of an animal or a plant or other articles worn by the subject from whom pests are to be repelled.

The term “chemical purity” refers to the degree to which a substance is undiluted or unmixed with extraneous material.

The term “comprising” is herein defined as “including principally, but not necessarily solely”. Further, the term “comprising” will be automatically read by the person skilled in the art as including “consisting of”. The variations of the word “comprising”, such as “comprise” and “comprises”, have correspondingly varied meanings.

The term “controlling pests” refers to the regulation or management of a pest, usually because it is perceived to be detrimental to a person's health, the ecology or the economy. In particular, controlling a species of pests refers to maintaining the population of the species of pests at a level that is not detrimental to a person's health, the ecology or the economy.

The term “extract” refers to any compound, composition or material which is extracted from one or more plants or portion(s) thereof. For example, neem extract refers to any compound, composition or material extracted from at least one neem leaf, seed, stem, bark, root, flower, fruit or the like. The neem extract may be neem cake, neem oil, neem powder, neem bitters or the like.

The term “locus” includes but is not limited to a plant or part thereof, plant propagation material for example a seed, soil, area, material or environment in which a pest is growing or may grow. In particular, locus may also refer to atmosphere, furniture, personal accessories, plastic products, cloth products, camping equipment, automotive and vehicular interiors, and the like. More in particular, the locus may include wooden materials such as trees, board fences, sleepers, etc. and buildings such as houses, outhouses, factories, but also construction materials, furniture, leathers, fibers, vinyl articles, electric wires and cables etc.

The term “plant and/or part thereof” refers to any plant or portion thereof, including but not limited to leaves, flowers, roots, seeds, pods, stems, fruits, seed coats, buds, and other parts of a plant. For the purpose of the present invention, the term “plant” may also include “herb”.

The term “pest” is an organism, usually an insect, which has characteristics that are regarded by humans as injurious or unwanted. The term “insect” includes but is not limited to organisms from the class Arachnida and Insecta. In particular, the insect may be from the order Acari of the class Arachnida. The insect may be at least one mite, tick or the like. The insect may be from the order Coleoptera, Dictyoptera, Diptera, Hemiptera, Hymenoptera, lsoptera, Mallophaga, Siphonaptera, Siphunculata and Thysanoptera of the class Insecta. In particular, the insect may include but not limited to one beetle, cockroach, mantis, true fly, sand fly, horse fly, gnat, mosquito, cicada, planthopper, leafhopper, shield bug, aphid, saw fly, bee, wasp, ant, termite, biting lice, cat flea, dog flea, human flea, Northern rat flea, Oriental rat flea, sucking lice, thrip and the like.

The term “subject” includes both human and animal subjects and parts thereof. Animal subjects include but are not limited to mammals, household pets and livestock animals. The animal subjects may include but are not limited to dogs, cats, birds, horses, cattle, pigs, sheep, goats, chicken, duck and turkey.

According to a first aspect, the present invention provides a method of repelling and/or controlling at least one pest, the method comprising contacting at least one subject, article and/or locus with a composition comprising:
(i) 2-undecanone, 2-tridecanone or a mixture thereof; and
(ii) neem plant, part and/or extract thereof.

According to another aspect, the present invention provides a composition for repelling and/or controlling at least one pest, the composition comprising:
(i) 2-undecanone, 2-tridecanone or a mixture thereof; and
(ii) neem plant, part and/or extract thereof.

Contacting of the composition may be by way of any method known in the art including, for example, spraying, pouring, dipping, in the form of concentrated liquids, solutions, suspensions, sprays, powders, pellets, briquettes, bricks and the like, formulated to deliver a composition in an effective concentration to kill, repel and/or control at least one pest.

Liquid formulations of the composition according to any aspect of the present invention may be aqueous-based or non-aqueous (i.e. organic solvents), or combinations thereof, and may be employed as foams, gels, creams, lotions, sunblock, oils, gels, sprays, suspensions, emulsions, microemulsions or emulsifiable concentrates or the like. The ingredients may include rheological agents, surfactants, emulsifiers, dispersants or polymers. In particular, the composition of the present invention may be for topical application.

The composition according to any aspect of the present invention may be formulated for dispersal. In particular, the composition according to any aspect of the present invention may be employed alone or in mixtures with one another and/or with such solid and/or liquid dispersible carrier vehicles as described herein or as otherwise known in the art, and/or with other known compatible active agents. The other known active agents may include but are not limited to insecticides, acaricides, rodenticides, fungicides, bactericides, nematocides, herbicides, fertilizers, growth-regulating agents and the like. The composition for disposal may be in the form of solutions, emulsions, suspensions, powders, pastes, granules and the like ready for use. The composition may be dispersed into the locus by way of a method known in the art, including spraying, fogging, micro-aerosolization, diffusion, atomizing or the like.

The composition according to any aspect of the present invention may be formulated for administering subcutaneously into the subject and/or into the article.

Neem plant, part and/or extract thereof used in the composition according to any aspect of the present invention may have pest repelling effects.

In particular, neem (Azadirachta indica) extract may be in the form of neem cake, neem oil, neem powder or the like. Neem powder may be a crystalline powder also known as “neem bitters”. Neem bitters may be divided into two sub-groups termed as limonoids and protolimonoids. Both these groups of bitter compounds play a crucial role in many of biological effects attributed to the plant species. The quantum of total bitters varies greatly, among different parts of Neem. Neem powder and all varieties of neem bitters known and available in the art may be used in the composition according to any aspect of the present invention.

The chemical purity of Neem extract may be in various ranges. In particular, the neem extract may have 0.1 to 100% chemical purity.

More in particular, the neem extract may be neem oil. The neem extract may be 0.1 to 100% neem oil. In particular, the neem extract may be 100%, 90% to 100%, 50% to 100%, or 25% to 100% neem oil. More in particular, the neem extract may be 0.1%, 0.25%, 0.5%, 1%, 2%, 10%, 50%, 99% neem oil. Neem oil may serve as a vehicle for 2-undecanone as it may retard the evaporation of 2-undecanone, prolonging 2-undecanone's skin residence activity.

Neem extract may be neem bitters. In particular, neem extract may be 0.1 to 100% neem bitters. In particular, the neem extract may be 100%, 90% to 100%, 50% to 100%, or 25% to 100% neem bitters.

The concentration of agents in the composition according to any aspect of the present invention may vary widely depending upon the nature of the particular formulation, particularly whether it is a concentrate or to be used directly as known to a skilled person.

The neem extract may be present in the composition in a concentration of at least about 0.0001% by weight and may be 0.1%, 0.25%, 0.5%, 1%, 2%, 10%, 50%, 99% or 100% by weight of the total composition.

2-undecanone, 2-tridecanone or the mixture thereof may be present in the composition according to any aspect of the present invention in a concentration of 0.01% to 99.9% w/w. In particular, 2-undecanone, 2-tridecanone or the mixture thereof may be 0.01% to 75% w/w, 0.01% to 50% w/w, 0.01% to 25% w/w, 0.01% to 10% w/w, 0.01% to 5% w/w or 0.01% to 2% w/w. More in particular, 2-undecanone, 2-tridecanone or the mixture thereof may be 2% to 5% w/w or 5% w/w. 2-undecanone may enhance the repelling effect of the neem extract.

The composition according to any aspect of the present invention may further comprise at least one other agent with pest repelling effect. The ingredient with pest repelling effects may include but are not limited to Citronella (Cymbopogon spp. In particular Cymbopogon nardus, Cymbopogon winterianus and Cymbopogon citratus), Eucalyptus (Eucalyptus spp.), Tea Tree (Melaleuca alternifolia), Lemon Eucalyptus (Corymbia citriodora), Cinnamon (Cinnamomum verum), Castor (Ricinus communis), Rosemary (Rosmarinus officinalis), Cedar (Cedrus spp.), Peppermint (Mentha×piperita), Clove (Syzygium aromaticum), Geranium (Pelargonium graveolens), Verbena (Verbena spp. in particular Verbena officinalis), Pennyroyal (Mentha pulegium), Lavender (Lavandula spp.), Pine (Pinus spp.), Cajeput (Melaleuca spp. in particular Melaleuca leucadendra), Basil (Ocimum basilicum), Thyme (Thymus vulgaris), Pandan (Pandanus amaryllifolius), Allspice (Pimenta dioica), Soybean (Glycine max), Garlic (Allium sativum), DEET, Picaridin, p-Mentane-3,8-diol, IR3535, Permethrin, Allethrin, Metofluthrin, Geraniol, Linalool, Eugenol, Cinnamaldehyde or the like.

The carrier of the agent with pest repelling effect may be from 0.1% to 99.9999% by weight of the total composition. The dry formulations will have from about 0.0001-95% by weight of the pesticide while the liquid formulations will generally have from about 0.0001-60% by weight of the solids in the liquid phase.

Having now generally described the invention, the same will be more readily understood through reference to the following examples which are provided by way of illustration, and are not intended to be limiting of the present invention.

### EXAMPLES

Standard molecular biology techniques known in the art and not specifically described were generally followed as described in Sambrook and Russel, Molecular Cloning: A Laboratory Manual, Cold Springs Harbor Laboratory, New York (2001).

### Example 1

### Colonization of Mosquitoes

Susceptible strain of Aedes mosquitoes were obtained from the Institute of Medical Research (IMR), Kuala Lumpur. Colonization is then managed in the Biomedical Science Insectarium, Faculty of Allied Health Sciences, UKM. Only adult female mosquitoes aged between three to seven days were used for the repellent testing while for the larvicidal testing, mosquito larvae were generally tested at the first instar stage.

### Repellent Testing

The repellent testing of 2-undecanone (Mostique EGX-101®, EntoGeneX Industries Sdn Bhd) was carried out using two methodologies; the Buescher's modified technique and the Standard and Industrial Research Institute of Malaysia (SIRIM) protocol. Mostique EGX-101® comprises 2-undecanone as the active ingredient. Observations were made on the response of the mosquito to a graded series of dosages and the ED₅₀ and ED₉₀ values computed. This test provided an estimation of the amount of repellent to be applied to the skin to produce a given level of effectiveness against mosquito test population.

Buescher's Modified Technique

For the Buescher's modified technique, a total of six volunteers were called in to test 2-undecanone. A chamber with a dimension size of 4×5×18 cm containing five 29 mm diameter holes were used whereby 15 mosquitoes were transferred into each chamber using a manual aspirator. The mosquitoes were starved for nearly 24 hours from 5 pm to 4 pm the next day. Volunteers were informed a day earlier to ensure they do not wear any perfume on the day of testing.

Experiments were done in the lab at room temperature. Preparation prior to each experiment included weighing 0.025 g of the desired repellent concentration and swabbing volunteers' forehands with 70% v/v alcohol before rinsing it with tap water. Next, five 29 mm diameter circles were drawn onto the forehands of each volunteer using a custom made plastic stencil with a pen. The different concentrations of repellent were then applied onto the respective circles using a spatula, leaving one circle empty for negative control.

Mosquitoes were then introduced by placing the chamber onto the forehand and the number of mosquito bites recorded after 60, 90 and 120 seconds of exposure. The testing for each concentration is repeated six times for all six volunteers. The percentage repellency is calculated by using the following formula (Ibrahim & Zaridah 1998):

$$\% Repellency = 100 - \frac{No . of bites on test area}{No . of bites on control area} \times 100$$

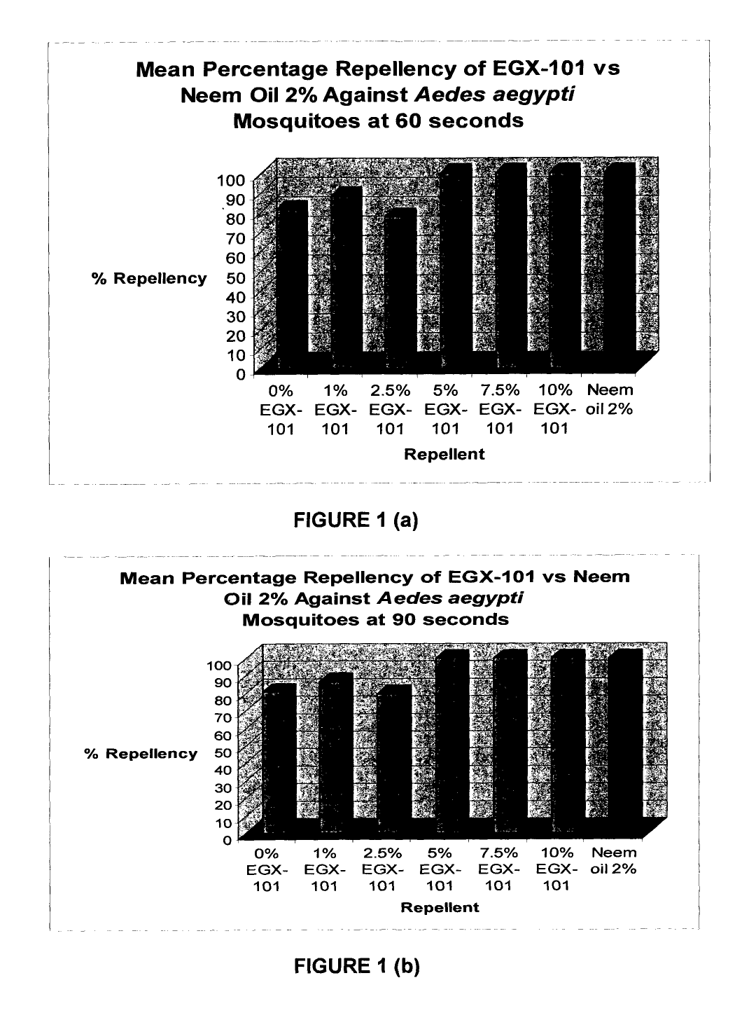

From the results shown in FIG. 1, EGX-101® was as effective as Neem oil 2% at a concentration as low as 5%, giving 100% repellency towards Aedes aegypti mosquitoes. The negative control, 0% EGX-101® also demonstrated high repellency and it was assumed that this was due to the strong fragrance of the lotion. The repellents of the higher concentrations must have affected the results of the negative control as the chamber used for testing did not have any partitions to prevent cross evaporation of neighboring test repellents.

SIRIM Protocol

The SIRIM protocol is a measure of the percentage protection reduction conducted according to Malaysian Standard (MS 1497:2000), modified from WHO 1996) which is more commonly known as the standard “arm-in-a-cage” mosquito repellent testing method.

EGX-101® with and without Neem oil was evaluated. Controls included arm areas that were untreated (i.e. without lotion) and arm areas that were treated with base lotion (i.e. Mostique lotion without EGX-101® and/or Neem oil comprising Aqua, Propylene Glycol, Dimethicone, Polysorbate-20, Paraffinum Liquidum, Partum, Carbomer and Triethanolamine). EGX-101® which is principally 2-undecanone was tested at concentrations of 2% and 5%. Neem oil concentrations included 0% and 0.1%. Testing was performed up to 8 hours for each sample with controls.

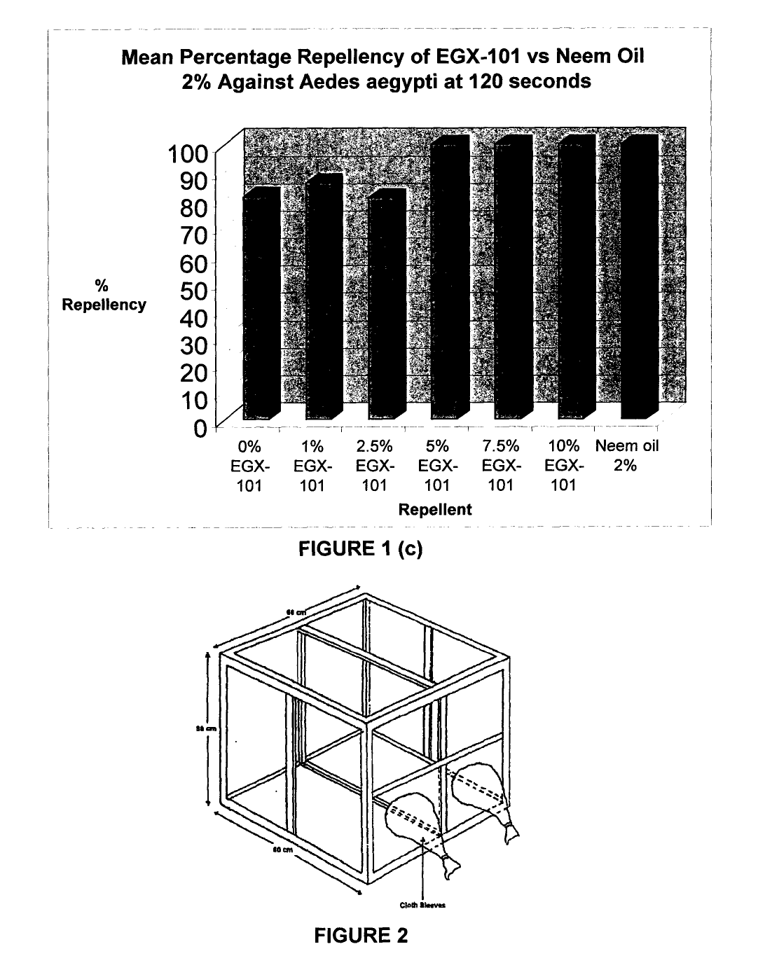

The study was conducted using a 60 cm×60 cm×60 cm cage with two 15 cm diameter circular opening fitted with cloth sleeves. The cage had two compartments divided by a Perspex partition in the middle as shown in FIG. 2. A fresh batch of 25 Ae. aegypti females, 3-7 days of age were introduced into each compartment through the circular opening. A square area of 25 cm² was drawn on one of the back hand of human volunteer. This area was not treated with anything for control (one hand) or pretreated with 0.4 g of lotion (the other arm) and left to dry for 10 minutes.

Both hands were covered with the rubber gloves with 25 cm² opening up to wrists to confine the bites to only the exposed areas and the hands were inserted through the circular opening into the cage containing mosquitoes. Both hands were exposed simultaneously for a period of three minutes and the numbers of mosquitoes landing/biting were recorded. The assessment period was 1, 2, 4, 6, and 8 hrs post-application. The effectiveness of the lotions was determined by the percentage protection reduction of mosquito biting/landing on treated arm when compared with untreated arm.

% Protection reduction=[(C−T)/C]×100

In this formula C is the total number of mosquitoes landing and/or biting at the control area (25 cm²) on human volunteer forearm without repellent material) and T is the total number of mosquitoes landing and/or biting the treated area. The % Protection reduction is rounded off to the nearest full percentage point.

Table 1 shows the results of using the base lotion only (no EGX-101®, no Neem oil) as compared to the no treatment (bare skin) control. Although the base lotion does show some repellency, it is ineffective as there is neither complete protection nor high protection (≧90% protection). The lotion by itself is not a sufficient mosquito repellent for reliable protection against mosquitoes biting and possibly transmitting diseases such as Dengue.

TABLE 1
Results when testing the Base Lotion (i.e. no EGX-101 ® (2-undecanone)
and/or Neem oil as a repellent against the untreated skin as the control.

| Time of | Number of Mosquito Biting/Landing | | |
|---|---|---|---|
| Exposure | Control (Bare Skin) | Test (Lotion) | % Protection |
| 0 h | 4 | 1 | 75 |
| 1 h | 5 | 1 | 80 |
| 2 h | 17 | 5 | 71 |
| 4 h | 13 | 5 | 62 |
| 6 h | 15 | 4 | 73 |
| 8 h | 10 | 5 | 50 |

Tables 2 and Table 3, respectively, show the repellency of 2% and 5% EGX-101® in combination with amounts of Neem oil (0 and 0.1%). Both 2% and 5% EGX-101® formulations showed complete protection for 2 hours (100% protection) but then the repelling ability began to reduce. For example, the 2% formulation of EGX-101® showed a loss of high protection (≧90% protection, Table 4) after 2 hours while the 5% EGX-101® still showed high protection up to 4 hours as was expected since it contained a larger amount of the EGX-101® repellent active ingredient.

Addition of just 0.1% Neem oil enhanced the activity of the formulation such that complete and high protection lasted for an average of 6-8 hours, longer than with EGX-101® alone and consequently providing enhanced protection against mosquito bites and the diseases vectored by mosquitoes.

TABLE 2
Percentage protection results when testing 2% EGX-101 ® with
0% and 0.1% concentration of Neem oil as a repellent.
2% EGX-101 ®; 0% Neem oil

| | Number of Mosquitoes | | |
|---|---|---|---|
| | Biting/Landing | | |
| Time of Exposure | Control | Test | % Protection |
| 0 h | 3 | 0 | 100 |
| 1 h | 3 | 0 | 100 |
| 2 h | 10 | 0 | 100 |
| 4 h | 15 | 2 | 87 |
| 6 h | 20 | 4 | 80 |
| 8 h | 20 | 5 | 75 |

2% EGX-101 ®; 0.1% Neem oil

| | Number of Mosquitoes | | |
|---|---|---|---|
| | Biting/Landing | | |
| Time of Exposure | Control | Test | % Protection |
| 0 h | 2 | 0 | 100 |
| 1 h | 5 | 0 | 100 |
| 2 h | 13 | 0 | 100 |
| 4 h | 20 | 0 | 100 |
| 6 h | 22 | 0 | 100 |
| 8 h | 23 | 3 | 90 |

TABLE 3
Percentage protection results when testing 5% EGX-101 ® with 0%
and 0.1% concentration of Neem oil as a repellent.
5% EGX ®; 0% neem oil

| | Number of Mosquitoes | | |
|---|---|---|---|
| | Biting/Landing | | |
| Time of Exposure | Control | Test | % Protection |
| 0 h | 4 | 0 | 100 |
| 1 h | 6 | 0 | 100 |
| 2 h | 6 | 0 | 100 |
| 4 h | 11 | 1 | 91 |
| 6 h | 22 | 3 | 86 |
| 8 h | 11 | 7 | 36 |

5% EGX-101 ®; 0.1% neem oil

| | Number of Mosquitoes | | |
|---|---|---|---|
| | Biting/Landing | | |
| Time of Exposure | Control | Test | % Protection |
| 0 h | 4 | 0 | 100 |
| 1 h | 7 | 0 | 100 |
| 2 h | 10 | 0 | 100 |
| 4 h | 15 | 0 | 100 |
| 6 h | 17 | 1 | 94 |
| 8 h | 19 | 2 | 90 |

TABLE 4
Time of Protection

| | Time of | Time of High |
|---|---|---|
| | Complete | Protection |
| | Protection | (≧90%) |
| Lotion Control (no EGX-101 ®, Neem Oil | 0 h | 0 h |
| 2% EGX-101 ®; 0% neem oil | 2 h | 2 h |
| 2% EGX-101 ®; 0.1% neem oil | 6 h | 8 h |
| 5% EGX-101 ®; 0% neem oil | 2 h | 4 h |
| 5% EGX-101 ®; 0.1% neem oil | 4 h | 8 h |

### REFERENCES

1. U.S. Pat. No. 7,288,573
2. U.S. Pat. No. 6,437,001
3. U.S. Pat. No. 7,531,188
4. Ibrahim & Zaridah 1998. Development of environment-friendly insect repellents from the leaf oils of selected Malaysian Plants. ASEAN Review of Biodiversity and Environmental Conservation (ARBEC), Article IV.
5. Sambrook and Russel, Molecular Cloning: A Laboratory Manual, Cold Springs Harbor Laboratory, New York (2001).

1. A method of repelling and/or controlling at least one pest, the method comprising contacting at least one subject, article and/or locus with a composition comprising:
(i) 2-undecanone, 2-tridecanone or a mixture thereof; and
(ii) neem plant, part and/or extract thereof.

2. The method according to claim 1, wherein the pest is selected from Arachnida or Insecta class.

3. The method according to claim 2, wherein the pest is selected from order Acari in the Arachnida class.

4. The method according to claim 2, wherein the pest is selected from order Coleoptera, Dictyoptera, Diptera, Hemiptera, Hymenoptera, Isoptera, Mallophaga, Siphonaptera, Siphunculata or Thysanoptera in the Insecta class.

5. The method according to claim 1, wherein the subject is at least one human or animal.

6-8. (canceled)

9. The method according to claim 1, wherein the article is made from polymer, wood, and/or textile.

10. The method according to claim 1, wherein the locus is a plant, plant propagation material, soil, area, material or environment in which a pest is growing or may grow.

11. The method according to claim 1, wherein the composition is formulated for topical application.

12. The method according to claim 11, wherein the formulation is a cream, lotion, sunblock, oil, gel or spray.

13. The method according to any one of claim 1 or 10, wherein the composition is formulated for dispersal.

14. The method according to claim 13, wherein the dispersal onto at least one subject, article and/or locus is in the form of spraying, fogging, micro-aerosolization, diffusion and/or atomizing.

15. The method according to claim 1, wherein the composition is formulated for administering and/or impregnating into at least one article.

16. The method according to claim 1, wherein the plant, part and/or extract thereof is in the form of oil and/or powder.

17. The method according to claim 1, wherein the plant, part and/or extract thereof has 0.1% to 100% chemical purity.

18. The method according to claim 1, wherein 2-undecanone, 2-tridecanone or the mixture thereof is 0.01% to 99.9% w/w.

19-21. (canceled)

22. The method according to claim 1, wherein 2-undecanone, 2-tridecanone or the mixture thereof is 5% w/w.

23. A method according to claim 1, wherein neem plant, part, and/or extract thereof is 0.01% to 99.9% w/w.

24-27. (canceled)

28. A method according to claim 1, wherein neem plant, part and/or extract thereof is 5% w/w.

29. A composition for repelling and/or controlling at least one pest, the composition comprising:
(i) 2-undecanone, 2-tridecanone or a mixture thereof; and
(ii) neem plant, part and/or extract thereof.

30-34. (canceled)

35. The composition according to claim 29, wherein the pest is at least one mite, tick, beetle, cockroach, mantis, true fly, sand fly, horse fly, gnat, mosquito, cicada, planthopper, leafhopper, shield bug, aphid, saw fly, bee, wasp, ant, termite, biting lice, cat flea, dog flea, human flea, Northern rat flea, Oriental rat flea, sucking lice, thrip, or bed bug.
